(19) United States
(12) Patent Application Publication
(10) Pub. No.: US 2012/0001828 A1
(43) Pub. Date: Jan. 5, 2012

(54) SELECTING DISPLAYS FOR DISPLAYING CONTENT

(76) Inventors: Andrew C. Gallagher, Fairport, NY (US); Andre C. Blose, Penfield, NY (US)

(21) Appl. No.: 12/826,825

(22) Filed: Jun. 30, 2010

(51) Int. Cl. G09G 5/00

(52) U.S. Cl. 345/1.1

(57) ABSTRACT

A method is disclosed for selecting displays for displaying content, including providing content to show in a particular environment containing a set of displays; providing to a processor an associated location of each display in the environment; and providing a model of human motion in the environment. The method further includes using the processor to select a subset of displays for showing the content based on the locations of the displays and the model of human motion; and showing the content on the selected subset of displays.

### FIELD OF THE INVENTION

The present invention is related to selecting displays for showing content in an environment by considering the motion of humans throughout the environment.

### BACKGROUND OF THE INVENTION

In many situations, a display such as a TV monitor or LCD screen, has many possible choices of content to show. For example, in the United States in 2008, the average American household received 118.6 channels according to Nielson Company. Typically, the choice of what content to view is made by a particular consumer. With the Internet, a consumer effectively has a choice between millions of possible content options to view at any given time.

In some situations, the choice of what content to place on a display is not made by a consumer, rather, the content stream is presented to the viewers with no explicit action on their parts. For example, in an airport, rows of display monitors shows departure and arrival times of flights throughout the airport. In some restaurants, televisions are placed throughout the dining area and are often tuned to various sports channels.

A number of patents teach selection of the content based on the characteristics of the viewers. For example, in U.S. Pat. No. 7,174,029 a system is described that senses the demographic category of a person or persons in view of a camera and then selects an advertisement targeted to that demographic category to display on a nearby kiosk or other display. In another example, in U.S. Pat. No. 7,629,896, a floor display is described which displays advertisements composed of images of the people who are viewing the display (e.g. milk can be advertised by superimposing a “milk mustache” onto an image of a viewer).

While these methods can be effective for advertising a product, they do not necessarily make an efficient use of the available displays. For example, in a shopping mall, there can be hundreds or thousands of displays. If the same content is shown on all monitors (e.g. the milk advertisement), the sale of milk can increase somewhat, but many potential customers who view the same advertisement again and again and who are not interested in purchasing milk can become bored. The prior art does not present a strategy for effectively managing assignment of content to displays in a manner that permits effective communication of one or more content streams to a broad audience of people.

### SUMMARY OF THE INVENTION

In accordance with the present invention, there is provided a method of selecting displays for displaying content, comprising:

(a) providing content to show in a particular environment containing a set of displays;

(b) providing to a processor an associated location of each display in the environment;

(c) providing a model of human motion in the environment;

(d) using the processor to select a subset of displays for showing the content based on the locations of the displays and the model of human motion; and

(e) showing the content on the selected subset of displays.

It is an advantage of the present invention that an effective method is provided for selecting and showing content to people in an environment that has a plurality of displays to obtain improved benefits in the effectiveness in communicating the content. These benefits are that the content is shown to an appropriate audience.

### BRIEF DESCRIPTION OF THE DRAWINGS

FIG. 1 is a block diagram illustrating the present invention; and

FIG. 2 is an illustrative environment map including displays.

### DETAILED DESCRIPTION OF THE INVENTION

The present invention will be directed in particular to elements forming part of, or in cooperation more directly with the apparatus in accordance with the present invention. It is to be understood that elements not specifically shown or described can take various forms well known to those skilled in the art.

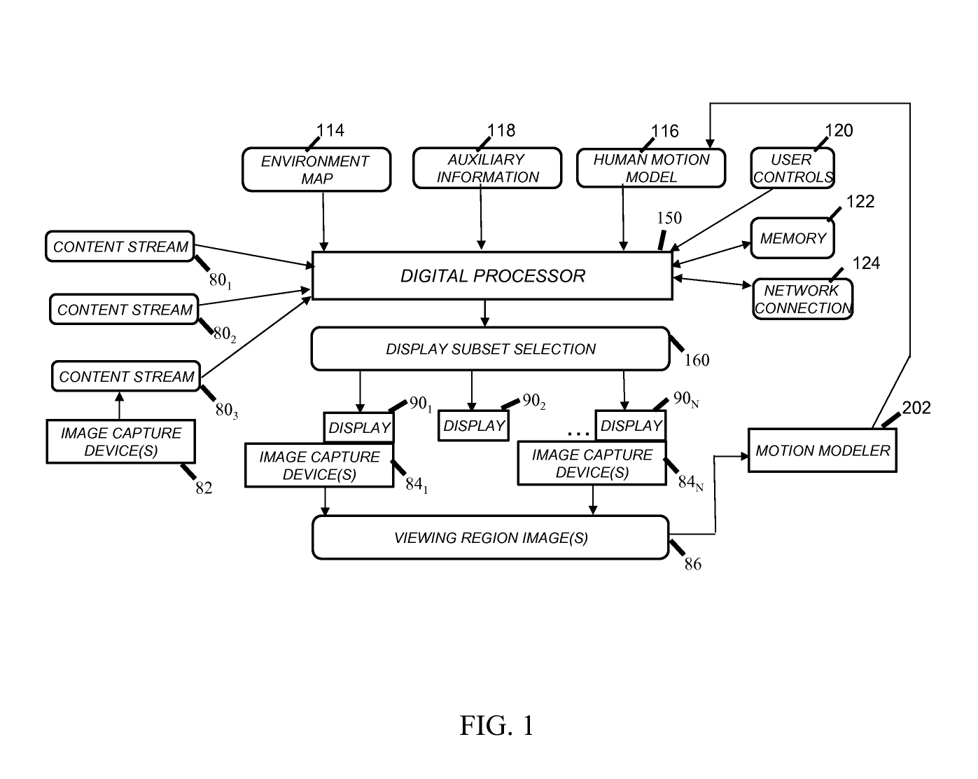

FIG. 1 shows a block diagram of the present invention. The purpose of the invention is to select a subset of digital displays for showing content. The selected displays are found by a processor which considers a map of an environment and the movement of people in the environment.

The present invention can also be implemented for use with any type of digital imaging device, such as a digital still camera, camera phone, personal computer, or digital video cameras, or with any system that receives digital images. As such, the invention includes methods and apparatus for both still images and videos. The images presented by a multi-view display can be 2D images, 3D images or images with more dimensions.

The system of FIG. 1 is capable of displaying content in a preferred and efficient manner. For convenience of reference, it should be understood that content streams 80₁, 80₂ and 80₃ refer to still images, videos, audio or collections of images. The content streams 80 can be of many types (e.g. emergency announcements, advertising messages, educational content, or entertaining content). Further, the content stream 80 can be an image that is captured with a camera or one or more image capture device(s) 82 as shown with content stream 80₃, or the content stream 80 can be an image generated on a computer or by an artist. Further, the content streams 80 include both single-view images (i.e. a 2D image) including a single perspective image of a scene at a time, or the image can be a set of images (a 3D image or video or a multi-view image) including two or more perspective images of a scene that are captured and rendered as a set. When the number of perspective images of a scene is two, the images are a stereo pair. Further, the content streams 80 include 2D or 3D video, i.e. a time series of 2D or 3D images. The content streams 80 include an associated audio signal. Although three content streams 80 are shown, there can be any number of content streams.

The present invention also includes a set of N displays 90₁, 90₂, . . . to 90_{N}, where each display is capable of displaying one or more content streams 80. A content stream can be thought of as a source of content. Typically, only one content stream 80 is displayed on a particular display 90, but in some cases, multiple content streams 80 are composted for showing on the display 90 such as is performed with picture-in-picture displays on television sets, or in different windows on a personal computer. In some cases, the display 90 has one or more associated image capture devices (for example, display 90₁ has image capture device(s) 84₁ and display 90_{N} has image capture device(s) 84_{N}). The image capture devices 84 that are associated with the display 90 captures viewing region image(s) 86 from which analysis is performed to determine viewing statistics such as how many people are viewing the displays 90, for how long, and how many people are passing by without viewing the displays 90.

The problem addressed by the present invention is to determine a subset of displays 90 for showing particular content streams 80. This decision is performed by a digital processor 150, and the result of the decision is a display subset selection 160. The display subset selection 160 assigns particular content streams 80 to particular displays 90 for showing the content streams 80.

Ideally, the display subset selection 160 determines the display subset selection 160 by considering several factors, including an environment map 114 that describes the spatial arrangement of the environment and the location of displays 90 within the environment, auxiliary information 118, and a human motion model 116 that describes the flow of people throughout the environment. Further, the digital processor 150 considers user input via user controls 120 and viewing region image(s) 86 for determining the display subset selection 160. The digital processor 150 accesses memory 122 for storing and buffering images, video, and audio information from the content streams 80 or the viewing region images 86. Further, the digital processor 150 has access to a network connection 124 (via a wired, wireless, or cellular connection) for additional storage and memory, or for accessing additional information such as is available on the Internet.

The digital processor 150 matches content streams 80 to displays 90 for the purpose of effective communication to a broad number of people. In one illustrative scenario, the system is deployed in a shopping center and each of several content streams 80 correspond to advertisements for different products (e.g. a video or still advertisement for toys, women's clothing, and men's clothing). Each of the content streams 80 has an associated demographic target (e.g. children, women, and men, respectively) that is indicated via the auxiliary information 118. The demographic targets can be based on age, gender, height, weight, income, education level, race, or other criteria. The digital processor 150 then determines subsets of the N displays 90 for showing each of the content streams 80. The subsets can contain 0, 1, or N displays 90 for showing a particular content stream 80. For example, the digital processor 150 receives information including the environment map 114 and the human motion model 116 that indicates that the shopping center contains two wings with mostly woman in the first wing and children in the second. The human motion model 116 is produces by any of a number of methods. For example, image capture devices 84 can be used to capture viewing region image(s) 86 in the environment, detect people or pedestrians, and then track them. Further, the human motion model 116 can be produces by considering historical traffic data (e.g. pedestrian traffic is typically higher in shopping centers the Friday after Thanksgiving than on other Fridays throughout the year.) The digital processor 150 then produces the display subset selection 160 that assigns the displays 90 in the first wing to display the content stream 80 that is an ad for women's clothing, and assigns the displays 90 in the second wing to display the content stream 80 that is an ad for toys. In this case, there are zero displays 90 in the subset of displays selected for showing the ad of men's clothing.

In some embodiments, the selection of display subsets by the digital processor 150 has the objective of displaying the content to a large number of unique people in the target demographic. Two simple strategies that could be used to assign content streams 80 to displays 90 would be to either have all displays 90 assigned to the same content stream 80 or to randomly assign each display 90 to a content stream 80. However, this strategy rarely results in an efficient communication of the messages of the content streams 80 to people in a particular environment, and the present invention improves on this strategy as follows. In the auxiliary information 118, there is contained an indication of the importance of each content stream 80. For example, an emergency message could have an importance of infinity, and other content streams 80 could have importances that are related to the amount of money that a person will pay to have that content stream 80 broadcast to a unique person of a target demographic. Then, the digital processor 150 seeks the display subset selection 160 that provides a good use of the displays 90 by evaluating a score function S as follows:

$$S = {\sum }_{M} {}_{m}^{}{{P}_{D}}{}_{m}^{} {i}_{m} \qquad ( 1 )$$

### Where:

S is a score such that higher values indicate better assignments of the content streams 80 to the displays 90.
m is the index of the content stream 80 and iₘ is an indication of the importance (or value) of the content stream.
Dₘ is a subset of the displays that are assigned the content stream m.
ₘP_{D}_{ₘ}, is the number of unique people that can view the displays in the subset Dₘ that are also in the desired demographic category for content stream m.
This equation can be altered or modified and still achieve the desired result that the decision of a display subset for showing the content stream 80 is based on both the locations of the displays 90 and the human motion model 116. The effectiveness of an assignment of displays 90 to content streams 80 is related to the total number of viewers of a specific demographic profile.

Certain factors of Equation (1) are time-variant. The factor ₘP_{D}_{ₘ} depends on the human motion model 116 or travel throughout the environment. The human motion model 116 can be represented in any number of ways. In one embodiment, the human motion model 116 specifies the likelihood of a person at a given location in the environment to travel to any location in the environment in a given amount of time. This human motion model 116 can be specified as a Markov chain with a transition probability matrix. A transition probability matrix is a square matrix where each entry (m,n) specifies the probability of moving from state (i.e. location) m to state (location) n in a specific number of time steps.

In one embodiment, the human motion model 116 is a collection of motion trajectories of people passing through the environment, and is formed by a motion modeler 202 which receives viewing region image(s) 86 from one or more image capture devices 84₁ to 84_{N}. In any case, the human motion model 116 can either be supplied to the digital processor 150, or actively sensed by tracking people in the environment using a set of image capture devices 84 to detect and track people throughout the environment and form an updated human motion model 116 (e.g. see Zhong, Shi and Visontai, Detecting Unusual Activity in Video, IEEE CVPR 2004).

Separate motion models are produced for each demographic class (e.g. male, female, children, adults or ethnic group). Determining a motion model for each class is accomplished by identifying the demographic class of persons in the environment using the image capture devices 84₁ to 84_{N} along with techniques that are known in the field of computer vision. Identifying the age, gender, and height of a person using images from a camera is described in, A. Gallagher, A. Blose, T. Chen, “Jointly Estimating Demographics and Height with a Calibrated Camera,” IEEE ICCV 2009. Then, a separate motion model is made for each demographic class by tracking the flow of individuals in the environment.

In another embodiment, the environment is monitored for changes in the human motion model 116 that are attributed to the content streams 80 shown on one or more displays 90. For example, if an interesting video is shown on a display 90, then nearby people will stop moving to watch it. In turn, other people observe that something is attracting the attention of a large number of people, and are diverted from their original destination to watch the content streams 80 on the display. Via the image capture devices 84, the motion modeler 202 determines a new human motion model 116 (i.e. that people are drawn to the display showing interesting content, the number of people watching the content, and the number of people passing by) and associates the new human motion model 116 with the content stream 80 that was being shown at the time. In this way, the people that are attracted to the content 80 are implicitly voting for the content, and indicating that it is interesting or valuable. Furthermore, because the distribution of people throughout the environment has now been changed (from the interesting content), any further determination of what content streams 80 to show on which displays 90 by evaluating Eq. (1) or a similar equation must change accordingly.

In any case, the human motion model 116 permits the computation of the unique number of people that can view the content shown on the display subset selection 160. Because of the human motion model 116, the digital processor 150 determines the number of unique viewers of a content stream 80, even when the content stream 80 is displayed at different times on specific displays in the subset of selected displays 90. For example, if a commercial is shown at 9 AM on a first display, then by 9:30, some of the people who had observed that commercial would move in their environment (as described by the human motion model) to locations where other displays are viewable. Then, the set of viewers when the commercial is shown again on another display 90 in the environment at a later time includes some of the people who had seen the advertisement at 9 AM, and some who are viewing the commercial (content stream 80) for the first time. In effect, the changes in the human motion model 116 that occur near the display 90 on which the content stream 80 is shown indicate the effectiveness of the content stream 80. Therefore, by monitoring changes to the human motion model 116, the effectiveness of the content stream 80 is gauged.

In some embodiments, the selection of the displays 90 by the digital processor 150 is performed with a greedy algorithm subject to constraints (auxiliary information 118) such as:

the display subset selection 160 for a given content stream 80 must contain either a fixed number of displays 90 or a range of the number of displays 90.

the objective is to have a large number of people view a content stream 80 at least a specific number of times. In this case, ₘP_{D}_{ₘ} represents the unique number of people that view the content stream m at least Q times.

In general, the problem (finding the best assignment of content streams 80 to displays 90 that maximizes (1)) is similar to the vertex cover problem that is NP-complete. So, approximate algorithms are implemented, such as a greedy search where the display subset selection 160 is initially empty. Then, (1) is evaluated for each possible assignment of each display 90 to each possible content steam 80 and the assignment that produces the greatest value of (1) is found. This process repeats until every display 90 is assigned to a content stream 80.

In some embodiments, the display subset selection 160 includes both an assignment of particular content streams 80 to particular displays 90 for showing content streams 80 and a schedule of times for displaying the content streams 80 on particular displays 90.

One strategy that is used by the digital processor 150 is to select displays 90 for a particular content stream 80 that are in high traffic areas (i.e. a large number of passers-by). Another strategy used by the digital processor 150 is to select displays 90 that are far apart in the environment to provide good coverage of the environment in the attempt to display the content to a large number of unique people.

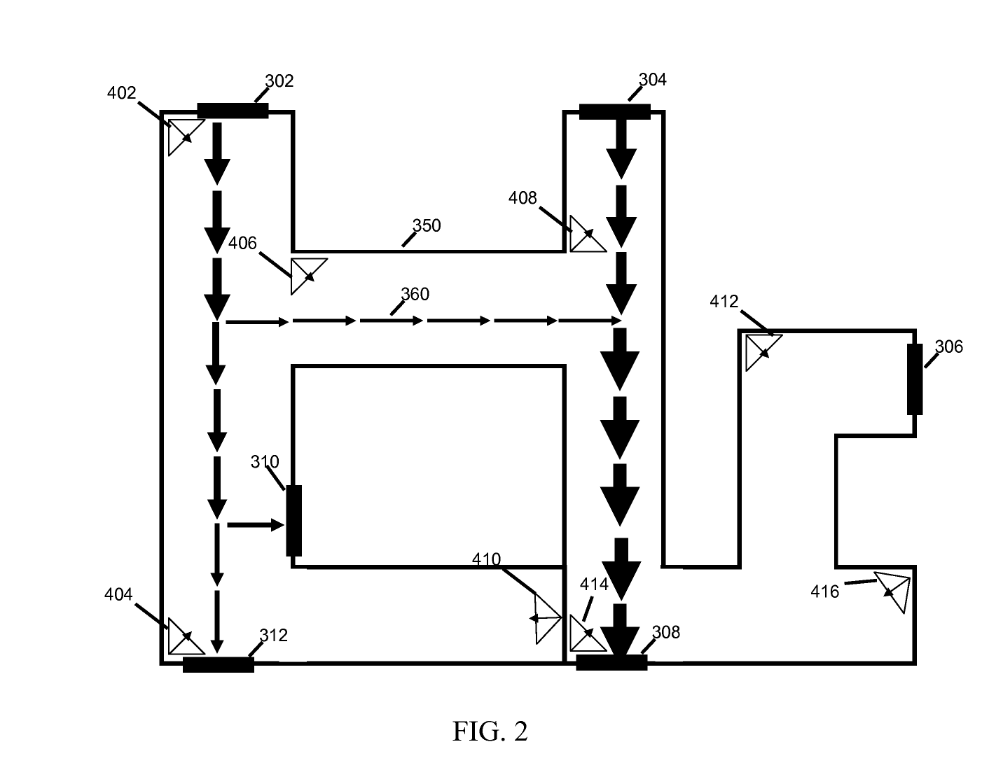

FIG. 2 shows an illustrative example of an environment map 350 of a building including entrances and exits at 302, 304, 306, 308, 310, and 312. Arrows 360 represent the human motion model 116 and provide an indication of the flow of people throughout the environment map 350. As indicated, people enter the building at 302 and 304, then move at an even pace through the building and exit at 310, 312 and 308. The thickness of the arrows 360 indicate the volume or number of people that pass through a particular section of hallway in a given time interval (e.g. 5 minutes). Displays 90 combined with image capture devices 84 are positioned in the environment map at locations 402, 404, 406, 408, 410, 412, 414 and 416. Suppose there is a content stream 80 that can be displayed on only one display 90. Then, the display 90 at location 414 is selected because of the large number of people that view it. Displays at locations at 402 and 408 are also reasonable choices. Now suppose that a content stream 80 is to be displayed on two displays 90. Then, the two selected displays 90 in the display subset selection 160 selected by the digital processor 150 are located at locations 414 and 402. Most of the people passing by location 402 will not pass by the display at location 414, although a small number of people can see the content stream 80 two times.

The invention has been described in detail with particular reference to certain preferred embodiments thereof, but it will be understood that variations and modifications can be effected within the spirit and scope of the invention.

### PARTS LIST

80 content steam(s)
82 image capture device(s)
84 image capture device(s)
86 viewing region image(s)
90 display(s)
114 environment map
116 human motion model
118 auxiliary information
120 user controls
122 memory
124 network connection
150 digital processor
160 display subset selection
202 motion modeler
302 entrance/exit
304 entrance/exit
306 entrance/exit
308 entrance/exit
310 entrance/exit
312 entrance/exit
350 environment map
360 arrows
402 locations
404 locations
406 locations
408 locations
410 locations
412 location
414 locations
416 locations

1. A method of selecting displays for displaying content, comprising:
(a) providing content to show in a particular environment containing a set of displays;
(b) providing to a processor an associated location of each display in the environment;
(c) providing a model of human motion in the environment;
(d) using the processor to select a subset of displays for showing the content based on the locations of the displays and the model of human motion; and
(e) showing the content on the selected subset of displays.

2. The method of claim 1, wherein the model of human motion provides one or more demographic categories, wherein the demographic categories include age, gender or ethnic group.

3. The method of claim 1, providing an image capture device located in the particular environment, and analyzing viewing region images captured with the image capture device to determine the model of human motion analyzing.

4. The method of claim 1, wherein there are multiple sources of content and the processor selects a subset of displays for each source of content and displays the appropriate content on each display of each subset of displays.

5. A method of determining the effectiveness of displayed content on a subset of displays, comprising:
(a) providing content to show in a particular environment containing a set of displays;
(b) using a processor and providing to the processor an associated location of each display in the environment;
(c) providing a model of human motion in the environment that describes the motion of people throughout the environment prior to displaying the content;
(d) selecting a subset of displays for showing the content based on the model of human motion;
(e) showing the content on the selected subset of displays; and
(f) determining changes to the motion model that result from displaying the content to determine the effectiveness of the content shown on the selected subset of displays.
